(19) United States
(12) Patent Application Publication
(10) Pub. No.: US 2009/0293240 A1
(43) Pub. Date: Dec. 3, 2009

(54) Shoelace holder

(76) Inventor: James Richard Hubbard, Wharton, NJ (US)

Correspondence Address: GEARHART LAW, LLC, 4 FERNDALE ROAD, CHATHAM, NJ, 07928, US

(21) Appl. No.: 12/455,010

(22) Filed: May 27, 2009

Related U.S. Application Data
(60) Provisional application No. 61/130,260, filed on May 29, 2008.

(51) Int. Cl. A43C 7/00; A44B 18/00; B23P 25/00

(52) U.S. Cl. 24/306; 24/712.1; 29/458

(57) ABSTRACT

The present invention is a method for creating a device suitable for holding a shoelace. The purpose of the invention is to prevent injuries caused due to the presence of excess shoelace length when a user is wearing a shoe. The device consists of a fastener with hook and loop fasteners on one side and a bridge on the other side. The laces of a shoe are threaded through the bridge and are secured using the hook and loop fastener. The invention is designed such that the excess shoelace length is directed parallel to the sole of the shoe, thereby minimizing the possibility of the excess shoelace length contacting the ground and posing a hazard to the user.

### CLAIM OF PRIORITY

This application claims priority to U.S. Ser. No. 61/130,260 filed May 29, 2008, the contents of which are fully incorporated herein by reference.

### FIELD OF THE INVENTION

This invention relates to the field of shoe accessories, more specifically to devices for containing shoelaces when on a shoe.

### BACKGROUND OF THE INVENTION

The present invention is an elegantly simple yet effective device for containing extra shoelace length on a shoe being worn by a user. When a shoe is tied, much of the lace is contained in the lacing format that holds the shoe tongue in place, and in the bow knot that is tied. However, in many instances there is an excess length of lace extending from the bow knot; this excess length of lace hangs off of the shoe and may contact the ground or be dragged along the ground when the user is moving. The danger of dragging laces is well known to users who wear lace up shoes, and is also well known to caretakers of children or handicapped adults.

Dragging shoelaces are a danger to both adults and children. They can cause accidents such as tripping, which is especially dangerous in sport activities, where a participant may be moving very quickly or pivoting. Dragging shoelaces also can become caught in machinery, causing injury. For instance, a shoelace, even though properly tied, can easily become caught in an escalator if there is sufficient length of the lace hanging off of the shoe. Dragging shoelaces can become caught in playground equipment, or may be stepped on when in a group, causing the user to trip and possibly fall.

Many attempts to address problems with shoelaces have been made; there is much art in the field of improving the shoelace and in providing devices to keep the lace tied when on a shoe. Prior art relevant to the present invention is described below.

U.S. Pat. No. 4,291,439 teaches a knot-securing device for the laces of shoes and other laced articles comprises a strap having adjoining surfaces of hook and loop elements. The strap is positioned to surround and contact the knot when the hook surface is brought into contact with the loop surface. An anchoring element may be fixed to the device to secure it to a lace.

U.S. Pat. No. 4,428,101 teaches a fastener incorporating a lace and a gripper. The gripper has a patch of a fastener material such as Velcro®. Areas of complementary fastener material are provided on the lace adjacent the ends thereof. When the lace is engaged with a lace-up article such as a shoe, the fastener material on the lace may be engaged with the fastener material on the gripper to maintain the lace under tension.

U.S. Pat. No. 4,571,854 teaches a knot latch device for footwear having structure readily adapted to receive a shoelace. The shoelace is then bowed about a portion of the knot latch device, and the knot latch device then folded about the bowed lace. The knot latch device includes a plurality of mating hook and loop elements to fasten the device securely about the bowed lace. Structure is included to mask at least a portion of the knot latch device when the device is secured about a bowed lace of the footwear.

U.S. Pat. No. 4,715,094 teaches a shoelace knot retainer that comprises top and bottom portions which are preferably hinged together. The bottom portion includes parallel side walls spaced by an opening which receives the shoelaces. The top portion includes ribs which lie adjacent the side walls when the top is engaged over the bottom. When the retainer is placed over a knot such that the knot is received between the side walls, the ends of the shoelace and the tips of the bow lie over the side walls and are clamped by the ribs when the top is engaged over the bottom. In a preferred embodiment, the ribs and the sidewalls have serrated edges to assist in gripping the shoelace.

U.S. Pat. No. 4,879,787 teaches a shoe lace knot securing device comprising a body, a pair of straps each having two ends wherein one end of each strap is permanently attached to one end of the said body and the other end of each strap is free and wherein the said straps extend outward from the said end of the said body, and an anchor loop provide at the other end of the said body, wherein the said body is provided with a fastener adapted to coact with a fastener on each of the said straps to detachably couple the free end of each of the said straps to the said body, and wherein each of the said straps is provided with a fastener adapted to coact with a fastener on the said body to detachably couple the said free ends of the said straps to the said body.

U.S. Pat. No. 4,949,437 teaches a device for retaining a knot of a shoelace. The device comprises a band with proximate and distal ends. The band is made of an elastic material, whereby the band may be stretched from a relaxed length to a stretched length. A rigid tab member comprises a proximate end portion connected to the proximate end of the elastic band, a distal end portion, and a lace slot cut entirely through the rigid tab member. A clip is affixed to the distal end of the elastic band for receiving the distal end portion in an attached state, wherein a force is applied by the elastic band attempting to retract the elastic band from its stretched length to its relaxed length, to maintain the distal end portion of the rigid tab member within the clip, and the knot is maintained in the lace slot and the shoelace clamped between the elastic band and the rigid tab member.

U.S. Pat. No. 4,999,888 teaches a shoelace retainer that includes a flexible, elongated strap member having a plurality of hook fastener elements on one surface thereof and a plurality of complementary loop fastener elements on an opposite surface thereof. A tab member having an elongated slot is disposed at a first end of the strap member for attaching the strap member to the footwear. The free ends of the shoelace are passed through the slot and the ends are tied in a conventional bowknot. The bow loops and free ends of the shoelace are placed on top of the strap member and the strap member is rolled up and onto itself, whereby the hook fastener elements become interlocked with the loop fastener elements, thereby confining the bow loops and free ends between convoluted layers.

U.S. Pat. No. 5,170,573 teaches a miniature pouch device which is removably attachable to the instep of a shoe for captivating the lace and bow used to tie the shoe, and retain them in a neat small package which sits in the location where the bow would normally reside on a conventional pair of shoes.

U.S. Pat. No. 5,778,500 teaches a knot securing device of particular benefit in securing shoelace knots made from a flexible material with a region having hook elements, a region having loop elements and a pair of apertures in the flexible material for allowing the open ends of a shoelace to pass through from one surface of the material to the opposite surface of the material, wherein the shoelace is then tied in a knot and the regions with the hook and loop elements are brought into contact to form a secure, but releasable, lock around the knot.

U.S. Pat. No. 5,913,483 teaches a shoelace securing device is in the form of an elongated strip of material with enlarged circular end portions that overlap upon assembly to cover the knot of a user's shoelaces. A rear side of the strip is completely covered with hook material to aid in gripping both the knot and adjacent shoelace material. The front surface has a loop patch at one end, the remainder of the front surface carrying an artistic design, other indicia, or logo. In one embodiment, the device includes two connectable, foldable strips of material. In each embodiment, a smooth surface is presented that can carry artwork, a slogan, words, a logo, or the like.

U.S. Pat. No. 6,601,323 teaches an invention that relates to a shoelace cover for use with an athletic shoe for covering the shoelaces to prevent the loosening or untying of a tied shoelace bow. The present invention is particularly applicable to wrestling shoes wherein the physical contact between wrestlers often; causes the wrestling shoes to become untied. The shoelace cover generally includes a length of material with ends that can be interconnected to form an adjustable cuff for extending about one's ankle. A front portion includes apertures for shoelaces to extend through the cover. Preferably, the shoelaces extend from the shoe to pass through the apertures of the cover and then back to the shoe to secure the cover to the shoe. The front portion includes a pocket on a back side. The shoelaces can be tied into a shoelace bow, tucked into the pocket, and the ends of the cuff can be secured about one's ankle to retain the shoelace within the pocket under the cover.

U.S. Pat. No. 6,952,864 teaches a shoelace retainer including a strip of loop-type fastening material that has been folded back upon itself near its midpoint and seamed in place so as to form a small tab. The tab is perforated so as to provide the strip of loop-type fastening material with an attachment ring. Adjacent the ring at one end of the strip of loop-type fastening material is attached a patch of hook-type fastening material.

US Patent Application 20020083620 teaches a shoelace cover for use with an athletic shoe for covering the shoelaces to prevent the loosening or untying of a tied shoelace bow. The present invention is particularly applicable to wrestling shoes wherein the physical contact between wrestlers often causes the wrestling shoes to become untied. The shoelace cover generally includes a length of material with ends that can be interconnected to form an adjustable cuff for extending about one's ankle. A front portion includes apertures for shoelaces to extend through the cover. Preferably, the shoelaces extend from the shoe to pass through the apertures of the cover and then back to the shoe to secure the cover to the shoe. The front portion includes a pocket on a back side. The shoelaces can be tied into a shoelace bow, tucked into the pocket, and the ends of the cuff can be secured about one's ankle to retain the shoelace within the pocket under the cover.

US Patent Application 20040163285 teaches a shoe with improved lacing means that includes a shoe, shoe laces and a hook and loop element pouch. On the underside, the side making contact with the shoe, are two openings that are used to slide the shoelaces through. With the pouch open, the shoelaces are pushed through the holes, pulled firmly and then tied as usual. Place the tied shoelaces down into the pouch. There is a hook and loop element strip on the opening making it easy to close, while keeping laces secure. The pouch can be attached to the shoe by hook and loop element strips on both the right and left underside of the pouch. The pouch will keep the shoelaces from loosening, snagging and untying.

US Patent Application 20050283956 teaches a footwear lace retainer that includes a first fabric sheet having a pair of spaced-apart openings for passage of the lace therethrough and a second fabric sheet secured to the first fabric sheet to form a pocket sized and shaped for receiving ends of the lace therein and having an open end facing toward the openings. A portion of the first fabric sheet forms a closure selectively foldable between a closing position wherein the open end of the pocket is closed and an opening position wherein the open end of the pocket is open. The openings are located between a fold line of the first fabric sheet and the open end of the pocket. A hook and loop fastener releasably secures the closure in the closing position. An attachment on the first fabric sheet opposite the pocket secures the first fabric sheet to the lace.

U.S. Design Pat. 270779 teaches an ornamental design for a shoelace bow knot retainer.

Although there is considerable art in the field of shoelace design and use, none of the art referenced above describes the present invention. Much of the art is concerned with keeping the shoelace tied in a bow knot, while the present invention assumes that the bow knot will stay tied and is designed to contain extra shoe lace length that is hanging from the bow knot.

Many of the patents referenced above use hook and loop fasteners such as Velcro® to secure the laces; all of these references use devices that contain hook and loop fasteners on opposite sides of the device. The present invention uses a superior type of fastener that functions when placed on only one side of the device, eliminating the need to have it on both sides. This is an important distinction in the art because it reduces manufacturing complexity and cost. It also makes the present invention easier to use than the devices that have hook and loop fasteners on both sides, because the user can fasten the present invention anywhere on its body, without having to match up complimentary pieces that are on opposite sides. This not only speeds the use of the present invention, it also makes the use less frustrating, particularly for children.

Another important distinguishing factor of the present invention is the direction in which the excess shoelace length is held. Many of the prior art devices show containment of the shoelace bow with any excess shoelace length extending out horizontally so that it is perpendicular to the sole of the shoe. This configuration allows any excess shoelace length to extend down the sides of the foot and onto the ground. The present invention holds the excess shoelace length vertically so that it is parallel to the sole of the shoe, and any excess length will extend down the shoe towards the toe. The possibility of the excess shoelace length contacting the ground is much reduced because the distance from the bow knot to the toe of the shoe is typically greater than the distance from the bow knot to the ground on the side of the shoe.

The size and bulkiness of the devices designed to contain shoelaces is also important. The present invention is less bulky than most of the prior art devices. This is attained in part because the hook and loop fasteners are on only one side of the invention, and also because the invention does not cover the knot, which takes a larger device and results in a bulkier final presentation. Additionally, other devices, such as the device described in U.S. Pat. No. 6,952,864 may flop around and be more of a nuisance to the user than an aid. The present invention is designed to be small, light, and unobtrusive, and to remain stationary, so that it contains the excess shoelace length but otherwise is minimally noticeable to the user.

### SUMMARY OF THE INVENTION

The present invention is a method for creating a device suitable for holding a shoelace, comprising the steps of creating a fastener having an adhering side and a backside, the fastener further having a length with first and second ends, the first end and the second end being removably attachable to each other when the first end of the adhering side is brought into contact with the adhering side of the second end, creating a loop suitable for holding tied shoelaces in general parallel orientation to the sole of a shoe, and attaching a bridge, suitable for attaching the fastener to the shoe laces of a shoe, wherein the bridge is in perpendicular orientation to the length of the fastener. In an alternate embodiment, the shoe lace holder can be sewn directly to the tongue of the shoe.

It is an object of the invention to contain excess shoelace length on a shoe.

It is an object of the invention to prevent injuries.

It is an object of the invention to provide a removable device for containing excess shoelace length on a shoe.

It is an object of the invention to provide a permanently attached device for containing excess shoelace length on a shoe.

It is an object of the invention to provide a device to contain excess length of any type of tying material when in use.

It is an object of the invention to direct excess shoelace length in a direction parallel to the sole of a shoe, thereby minimizing the possibility of the excess shoelace length contacting the ground when a user is wearing the shoe.

### BRIEF DESCRIPTION OF THE DRAWINGS

FIG. 1 is a perspective view of a preferred embodiment of the invention in use on a shoe.

FIG. 2 is a perspective top view of a preferred embodiment of the invention.

FIG. 3 is perspective bottom view of a preferred embodiment of the invention.

FIG. 4 is a bottom view of a preferred embodiment of the invention.

FIG. 5 is a top view of a preferred embodiment of the invention.

FIG. 6 is side view of a preferred embodiment of the invention.

FIG. 7 is a front view of a preferred embodiment of the invention.

FIG. 8 is a perspective view of an alternate embodiment of the invention in use on a shoe.

### DESCRIPTION OF THE PREFERRED EMBODIMENTS

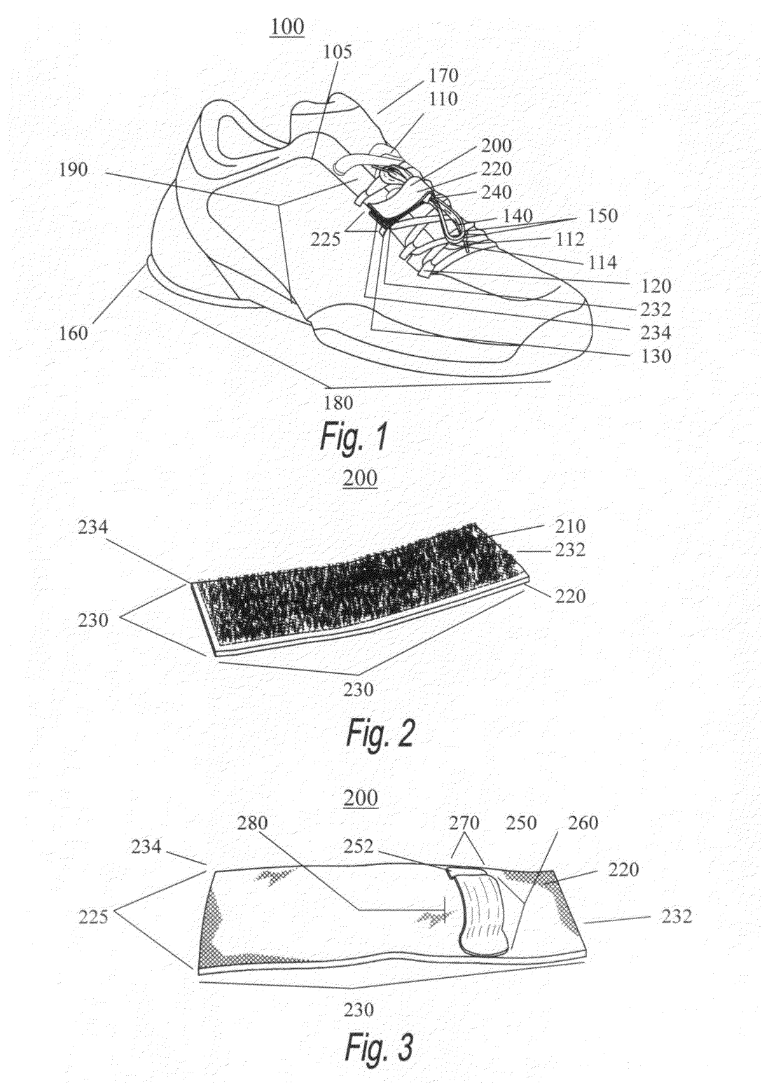

FIG. 1 illustrates one embodiment of the present invention in use on a shoe. FIG. 1 shows a shoe 100 with a shoe body 105 that has a lug or eyelet 120, a third lug or eyelet 130, a shoe sole 160, a shoe tongue 170, a shoe sole length 180, and a shoe tongue to ground length 190. Also shown is a shoelace 110 that has shoelace first end 112, a shoelace second end 114, a shoelace bow 140, and a shoelace excess length 150.

FIG. 1 also shows the present invention, which is fastener 200 with a fastener backside 220, fastener width 225, fastener first end 232, fastener second end 234, and fastener loop 240.

The shoe used for illustrative purposes in FIG. 1 is an athletic shoe, although the present invention will function on any shoe with laces, such as a boot or street shoe, etc. or on any object that contains tied materials of any type, such as but not limited to, hoods, blouses, skirts, medical devices or procedures that use tied materials, cargo or trunk tie downs, or anywhere that material is tied and excess length is a concern. Additionally, the present invention may be used with any type of shoelace or string-type object, made from any materials and of any width or length.

The shoe of FIG. 1 is shown with the laces secured in a common criss-cross pattern. Because the purpose of the present invention is to secure excess length after a shoelace or other string-type object is tied, it may be used with any type of lacing pattern, knot, or tying method.

FIG. 2 is a perspective top view of the fastener 200 which shows the fastener adhering side 210, fastener backside 220, fastener width 225, fastener length 230, fastener first end 232, and fastener second end 234.

FIG. 3 is a perspective bottom view of the fastener 200 which shows the fastener backside 220, fastener width 225, fastener length 230, fastener first end 232, fastener second end 234, bridge 250, bridge first end 252, bridge second end 254, bridge length 260, bridge width 270 and bridge depth 280.

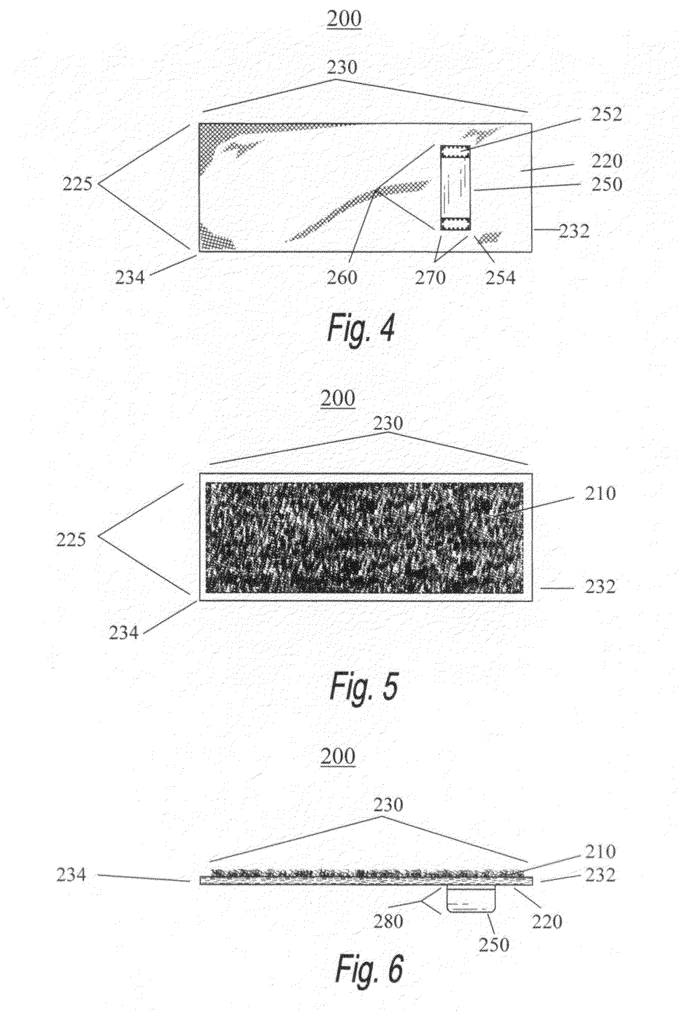

FIG. 4 is a bottom view of the fastener 200 which illustrates fastener backside 220, fastener width 225, fastener length 230, fastener first end 232, fastener second end 234, bridge 250, bridge first end 252, bridge second end 254, bridge length 260, and bridge width 270.

FIG. 5 is a top view of the fastener 200 that shows the fastener adhering side 210, fastener width 225, fastener length 230, fastener first end 232, and fastener second end 234.

FIG. 6 is a side view of the fastener 200 that shows the fastener adhering side 210, fastener backside 220, fastener length 230, fastener first end 232, fastener second end 234, bridge 250, and bridge depth 280.

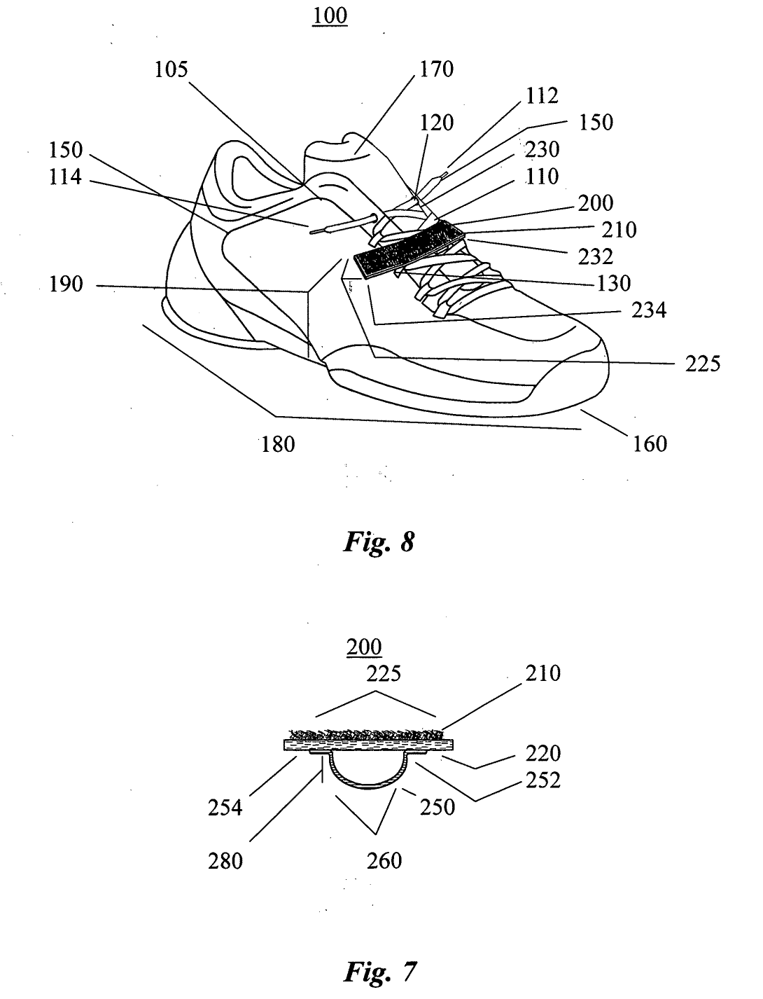

FIG. 7 is a front view of the fastener 200 that shows the fastener adhering side 210, fastener backside 220, fastener width 225, bridge 250, bridge first end 252, bridge second end 254, bridge length 260, and bridge depth 280.

The present invention is employed in the following manner: a shoelace 110 is laced onto a shoe 100 by threading the shoelace 110 in the commonly used criss-cross pattern through lugs or eyelets 120 to about half way up the tongue of the shoe, or, for a shoe with six lugs or eyelets, to the third lug or eyelet 130. Once the shoelace 110 is through the third lug or eyelet 120, the fastener 200 is held above the shoe tongue 170 with the fastener backside 200 and the bridge 250 facing the shoe 100, and the fastener adhering side 200 facing up and away from the shoe. The shoelace first end 112 and the shoelace second end 114 are both threaded through the bridge 250 to secure the fastener 200 in place on the shoelace. The shoelace 110 is then laced through the remaining lugs or eyelets 120 to the top lug or eyelet 120 where it is tied, typically in a bow knot that results in the shoelace bow 140. The shoelace bow 140 and the shoelace excess length 150 from both the shoelace first end 112 and the shoelace second end 114 are placed on the fastener adhering side 210. The fastener first end 232 of the fastener adhering side 210 is then brought into contact with the fastener second end 114 of the fastener adhering side 210 so that the fastener 200 is adhered to itself to form fastener loop 240 with the shoelace bow 140 and shoelace excess length 150 secured inside.

In a preferred embodiment, the bridge 250 is a piece of elastic fabric, and is sewn to the fastener 200, with an integrated hook and loop material on the fastener adhering side 210, and fabric on the fastener back side 220. As used herein, the term “integrated hook and loop fastener” means a hook and loop fastener having the hooks and loops on the same side of the fabric and alternating in a manner that allows two ends of a single strip to be pressed together. This is sometimes referred to as “alternating row” hook and loop fasteners. The integrated hook and loop fastener is available from Aplix, In (Charlotte, N.C.).

This configuration results in the shoelace excess length 150 traversing parallel to the shoe sole length 180, which generally is a greater distance than the shoe tongue to ground length 190. This yields the advantage of the shoelace excess length 150 being distributed over a greater distance before possible contact with the ground than if the shoelace extra length 150 was distributed perpendicular to the shoe sole 160, as it is in the prior art. The present invention thereby is the more effective device for minimizing the possibility of the shoelace extra length 150 dragging and becoming a hazard to the user of the shoe 100.

The figures illustrate the bridge 250 of the fastener 200 attached to the shoelace 110 at the third lug or eyelet 130 of the shoe 100, but the bridge 250 may be fastened in anywhere along the length of the shoelace 110.

The primary purpose of the invention is to capture shoelace excess length 150, therefore the shoelace bow 140 may or may not be contained in the fastener 200.

FIG. 8 illustrates an alternate embodiment of the present invention in use on a shoe. FIG. 8 shows a shoe 100 with a shoe body 105 that has a lug or eyelet 120, third lug or eyelet 130, shoe sole 160, shoe tongue 170, shoe sole length 180, shoe tongue to ground length 190, and a shoelace 110 that has a shoelace first end 112, shoelace second end 114, and a shoelace excess length 150.

FIG. 8 also shows a fastener 200 that has a fastener adhering side 210, fastener width 225, fastener length 230, fastener first end 232, and fastener second end 234.

In the embodiment illustrated in FIG. 1, the fastener 200 is removably attached to the shoelace 100 and is not attached to the shoe 100. In the embodiment illustrated in FIG. 8, the fastener first end 232 is permanently adhered to the shoe 100 either by adhering to the shoe tongue 170 or to the shoe body 105 while the fastener second end 234 is not attached. Alternately, the fastener second end 234 may be adhered to the shoe body 105 or shoe tongue 170 while the fastener first end 232 is not attached. In the embodiment of FIG. 8, the fastener 200 may be adhered to the shoe body 105 or the shoe tongue 170 using any means, including but not limited to, sewing, riveting, welding, gluing, heat fusing, stapling, or snapping.

In a preferred embodiment, the fastener length 230 may be ⅛ inch to 48 inches, with a preferred length in the range of 3 to 5 inches. The fastener width 225 may be ⅛ inch to 48 inches, with a preferred width of ½ to 5 inches. The bridge length 260 may be ⅛ inch to 48 inches, with a preferred length of ¾ inch to 3 inches, the bridge width 270 may be 1/64 inch to 48 inches, and the bridge depth 280 may be 1/64 inch to 48 inches with a preferred depth of 1/16 inch to 1 inch. The fastener adhering side 210 may be the same size as the fastener backside 220, or it may be smaller or larger and may be distributed in any pattern on the backside 220. The preferred fastener is 3.5 inches long by 1 inch wide, bridge is about 1.25 inches long by ½ inch wide by ¼ inch deep.

In both embodiments illustrated in the figures, the bridge may be attached to the fastener by a number of means, including but not limited to, sewing, welding, gluing, heat fusing, stapling, riveting, or snapping. Alternately, the fastener back side 220 and the bridge 250 may made from one continuous piece of the same material. There may be one bridge 250 on the fastener 200 as illustrated in the figures, or there may be a plurality of bridges 250 on the fastener 200, for instance, from 1 to 3 bridges 250 on the fastener 200. The bridge may be rigid or flexible and may or may not stretch The fastener 200 may be flexible, stretchable or rigid. The materials used to manufacture the fastener may include, but are not limited to, integrated hook and loop fasteners, fabrics, adhesives, metals, plastics, animal products, composites, or any combination of these or other materials.

The fastener adhering side 210 may adhere through the use of, but is not limited to, integrated hook and loop fasteners, adhesives, snaps, suction, magnetic, physical or chemical attractive force, the use of material that has a male/female union, or any other method that allows adhesion.

The bridge 250 may flexible, stretchable, or rigid. It may be made from any material, including but not limited to, integrated hook and loop fasteners, fabrics including but not limited to elastic and other stretchable fabrics, adhesives, metals, plastics, glass or glass products, wood or wood products, animal products, composites, or any combination of these or other materials.

Although the fastener 200 and the bridge 250 are illustrated as rectangles, they can be the same or different shapes, and they can be any shapes, including but not limited to, a circle, square, star, triangle, polygon, cartoon object, caricature, vehicle, or any other shape.

Additionally, the fastener 200 and the bridge 250 may be any color or colors, and there may be more than one color on each component. The fastener 200 and bridge 250 may contain images, indicia, or both, including but not limited to, advertising, photos, digital images, slogans, names, or any other desired image or indicia. The image or indicia may be transferred to the fastener 200 and bridge 250 through any process, including printing, integrating in the materials production process, gluing, screening, engraving, or any other process. The fastener 200 and bridge 250 may both have images or indicia, or only one of them may contain images or indicia. In the embodiment where a multitude of bridges 250 are attached to the fastener 200, the images and/or indicia may be identical or varying, in any combination.

Although this invention has been described with a certain degree of particularity, it is to be understood that the present disclosure has been made only by way of illustration and that numerous changes in the details of construction and arrangement of parts may be resorted to without departing from the spirit and the scope of the invention.

I claim:

1. A method for creating a device suitable for holding a shoelace, comprising the steps of:
creating a fastener having an adhering side and a backside, the fastener further having a length with first and second ends, the first end and the second end being removably attachable to each other when the first end of the adhering side is brought into contact with the adhering side of the second end, creating a loop suitable for holding tied shoelaces in general parallel orientation to the sole of a shoe; and
attaching a bridge, suitable for attaching the fastener to the shoe laces of a shoe, wherein the bridge is in perpendicular orientation to the length of the fastener.

2. The method of claim 1, wherein the bridge is sewn to the fastener.

3. The method of claim 1, wherein the bridge is welded to the fastener

4. The method of claim 1, wherein the bridge is glued to the fastener.

5. The method of claim 1, wherein the adhering side is an integrated hook and loop fastener.

6. The method of claim 1, wherein the adhering side is and adhesive.

7. The method of claim 1, wherein the bridge is plastic.

8. The method of claim 1, wherein the bridge is made of elastic.

9. The method of claim 1, wherein the bridge is made of cloth.

10. The method of claim 1, wherein the fastener has a plurality of bridges.

11. An article of manufacture made according to claim 1.

12. An article of manufacture, comprising:
a shoe having a tongue;
the tongue having a fastener with an adhering side and a backside, the fastener further having a length with first and second ends, the first end and the second end being removably attachable to each other when the first end of the adhering side is brought into contact with the adhering side of the second end, creating a loop suitable for holding tied shoelaces in general parallel orientation to the sole of the shoe.

13. The article of claim 12, wherein the adhering side is an integrated hook and loop fastener.

14. The article of claim 12, wherein the adhering side is an adhesive.

15. The article of claim 12, wherein the fastener is attached to the tongue with a rivet.

16. The article of claim 12, wherein the fastener is sewn to the tongue.
